(19) United States
(12) Patent Application Publication
(10) Pub. No.: US 2011/0035807 A1
(43) Pub. Date: Feb. 10, 2011

(54) Devices and Methods of Clustered Displays

(75) Inventors: William P. Alberth, Prairie Grove, IL (US); Steve R. Bunch, Harvard, IL (US); Gary W. Grube, Barrington, IL (US); Robert J. O'Dea, Fort Lauderdale, FL (US); William L. Olson, Palatine, IL (US); Frederick W. Vook, Schaumburg, IL (US)

Correspondence Address: MOTOROLA MOBILITY, INC, 600 NORTH US HIGHWAY 45, W2-55BB, LIBERTYVILLE, IL, 60048-5343, US

(73) Assignee: MOTOROLA, INC., Schaumburg, IL (US)

(21) Appl. No.: 12/535,796

(22) Filed: Aug. 5, 2009

(51) Int. Cl. H04L 9/00; G06F 15/16; G06F 17/30; H04B 1/38; G09G 5/00

(52) U.S. Cl. 726/27; 709/203; 345/428; 455/90.1; 345/1.3

(57) ABSTRACT

Disclosed are devices and methods of communication devices that are configured to be a part of clustered displays. A communication device may be a mobile communication device. Such a device may include a cluster module configured to determine that the device is a license owning unit, a content module configured to receive data including content via a transceiver when it is determined that the device is a license owning unit and a distribution module configured to transmit output data via a transceiver, the output data being at least one portion of the data. The license owning unit is determined based on the reception characteristics of the devices of the cluster. The distribution by the license owning unit to other devices in the cluster is at the lowest resolution of any of the devices of the cluster.

### INCORPORATION BY REFERENCE

The present application hereby incorporates by reference the contents of U.S. application Ser. No. 11/961,418 to Francesca Schuler, Marc Kenneth Chason, Krishna Jannalagadda, and Xun Luo, filed Dec. 20, 20077, for METHOD FOR CLUSTERING DISPLAYS OF DISPLAY DEVICES.

### FIELD

Disclosed are devices and method of clustered displays for determining a license owning unit.

### BACKGROUND

Small, medium sized or large display screens, such as flat panel display screens may be arranged in a cluster so that a portion of the content shown on each one simultaneously can form a whole image. Portable electronic devices including cellular telephone handsets, personal digital assistants (PDAs), and handheld gaming devices among other devices can be configured so that they may form clustered displays as well. Portable electronic devices have become increasingly popular, particularly in mobile societies. Clustering of multiple portable electronic devices provides an alternative means for obtaining effectively, a large display.

A benefit of portable communication devices is their ability to download content. As mentioned, it would be beneficial to be able to cluster displays of communication devices to obtain a large display. However, to receive content, an entity such as the owner of a display device typically must license the content from a distributor. As clustered communication device display technology improves, digital rights management can become an issue in content delivery and distribution.

### BRIEF DESCRIPTION OF THE DRAWINGS

FIG. 1 depicts an embodiment of a cluster of display devices;

FIG. 2 depicts an embodiment of a device configured to be part of a cluster of devices;

FIG. 3 is a flowchart of an embodiment of a method of determining which device of clustered displays should be a licensed owning unit;

FIG. 4 is a flowchart of an embodiment of a method of deleting the licensed device and determining which device of clustered displays should be a licensed owning unit;

FIG. 5 is a flowchart of an embodiment of a method of determining which device of clustered displays should be a licensed device after adding a device to the cluster; and

FIG. 6 is a flowchart of an embodiment of a method of a license device determining the resolutions of the cluster when devices are deleted and/or added to the cluster.

### DETAILED DESCRIPTION

When there is a plurality of devices forming clustered displays, the digital rights management of the content determined by the devices themselves may determine the master/slave arrangement of devices, at least in terms of content delivery. Disclosed are devices and methods of communication devices that are configured to be a part of clustered displays. A communication device may be a mobile communication device. Such a device may include a cluster module configured to determine that the device is a license owning unit, a content module configured to receive data including content via a transceiver when it is determined that the device is a license owning unit and a distribution module configured to transmit output data via a transceiver, the output data being at least one portion of the data. The disclosed methods may address the digital rights management issues by streamlining the process of obtaining a license by one device of the clustered displays and avoid duplicity of licenses taken by two or more devices of the clustered displays.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

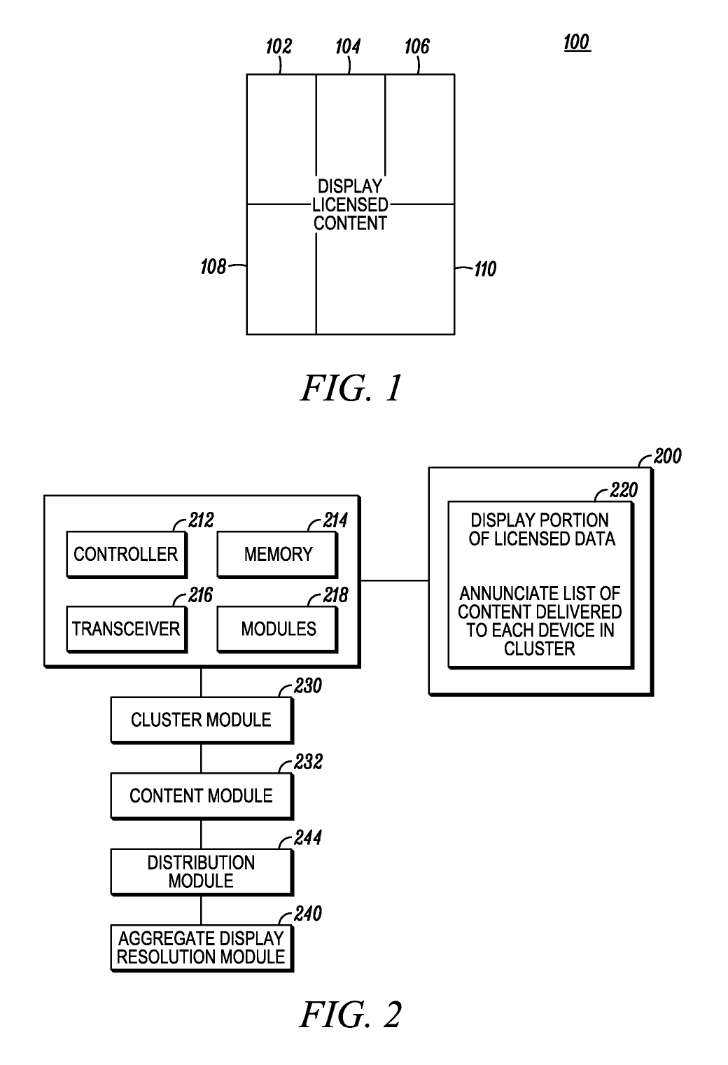

FIG. 1 depicts an embodiment of a cluster of display devices 100. In the example of FIG. 1, five devices having displays 102, 104, 106, 108 and 110 are in an interrelated arrangement. In the example of FIG. 1, two or more units with displays are aligned to form a cluster of displays 100. It is understood that the clustered displays 100 can take on any suitable interrelated arrangement. The displays are of communication devices that can electronically communicate between themselves, for example, so that a license owning unit may be determined, and so that an aggregate display resolution can be determined. The license owning unit can transmit one or more portions of data to one or more other devices. In one embodiment, the displays are of mobile communication devices.

FIG. 2 depicts an embodiment of a device 200 configured to be part of a cluster of devices 100 (see FIG. 1). The device 200 includes a controller 212, a memory 214 configured to communicate with the controller 212 and configured to store modules 218 and at least one transceiver 216 configured to communicate with the controller 212. The at least one transceiver 216 can receive content and/or distribute portions of the content to other devices as is described in detail below. The device 200 includes a display 220 configured to communicate with the controller 212. As mentioned above, the device 200 and its display 220 can be of any configuration. The device 200 is a communication device that is configured to become a license owning unit. The device 200 may be a mobile communication device, netbook, or laptop.

A license owning unit is a member of the set of units in the display cluster 100 (see FIG. 1) that is authorized to receive specific content. The license owning unit may receive content data in any suitable manner, such as by communication with a distributor of content via transceiver 216. A cluster module 230 can be configured to determine whether the device is a license owning unit determined by the reception characteristics of the devices of the cluster, as will be discussed in detail below. A content module 232 can be configured to receive data including content via a transceiver 216 when it is determined that the device 200 is a license owning unit. A distribution module 244 can be configured to transmit output data via a transceiver 216, the output data being at least one portion of the data. Additionally, the device 200 can include an aggregate display resolution module 240 configured to determine the resolutions of each display device of cluster 100, to determine which of the resolutions is the lowest resolution and to scale the output data to have a resolution equivalent to the lowest resolution. The display 220 can display a portion of the licensed data when it is clustered with other devices, and can annunciate a list of content characteristics related to the other devices of the cluster. It is understood that any type of format of annunciation is in the scope of this discussion.

The modules can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

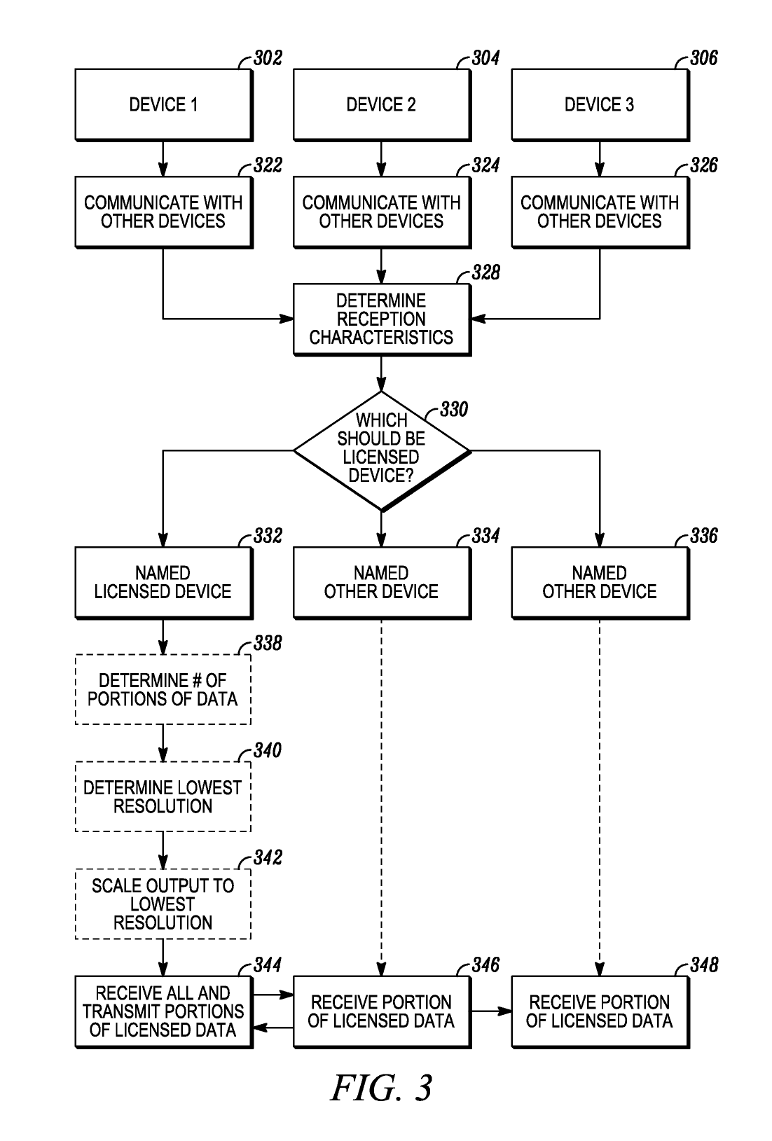

FIG. 3 is a flowchart of an embodiment of a method of determining which device of clustered displays 100 (see FIG. 1) should be a licensed owning unit, or licensed device. Any number of individual displays may form clustered displays 100. The user has entered commands to the controller 212 via a user interface (not shown) determining content that is to be displayed. Here, three devices 302, 304 and 306 are illustratively depicted. To determine which device should be the licensed owning unit, two or more device communicate 322, 324 and 326 with one another to determine 328 and share one or more reception characteristics of two or more devices of the cluster 100. Reception characteristics may include for example, the signal to noise ratio, the bit error rate, the frame error rate and/or the packet error rate. A determination can be made as to which device has the best reception quality. That is, it may be determined which member of the set is receiving the best signal or is experiencing the lowest error rate. Accordingly, the method includes selecting 330 a device from the two of more devices 302, 304 and 306 based on the one or more reception characteristics as a licensed device in accordance with the cluster module 230 (see FIG. 2) configured to determine that the device is a license owning unit. In this manner the cluster 100 includes the licensed device 332 and one or more other devices 334 and 336. The licensed device 332 is accordingly chosen and configured to be an owning unit of a license to receive data including licensed content in accordance with the content module 232 configured to receive data including content via a transceiver 216 when it is determined that the device is a license owning unit.

Prior to transmitting data to the other devices 334 and 336 of the clustered displays 100 (see FIG. 1), interim and/or optional steps may be taken by the license owning unit 332. The steps 338, 340 and 342 may be optional since the information provided by these steps may have been previously obtained and stored by the license owning unit 332. A determination 338 may be made as to the number of portions of the data to be transmitted based upon the number of devices in the cluster. Also, so that the content displayed across the cluster is provided in the most seamless manner, there may be a determination of the resolution of each display device and determining 340 which resolution is the lowest resolution. The output of the licensed owning unit 332 may then be scaled 342 to have a resolution equivalent to the lowest resolution.

The data may be divided so that it may be transmitted 344 by the licensed device in one or more portions of the data to one or more other devices so it may be received 346 and 348 in accordance with distribution module 244 in communication with the controller 212, the distribution module 244 configured to transmit output data via a transceiver 216, the output data being at least one portion of the data. Accordingly, the content may be displayed by the cluster 110 (see FIG. 1) at the lowest resolution.

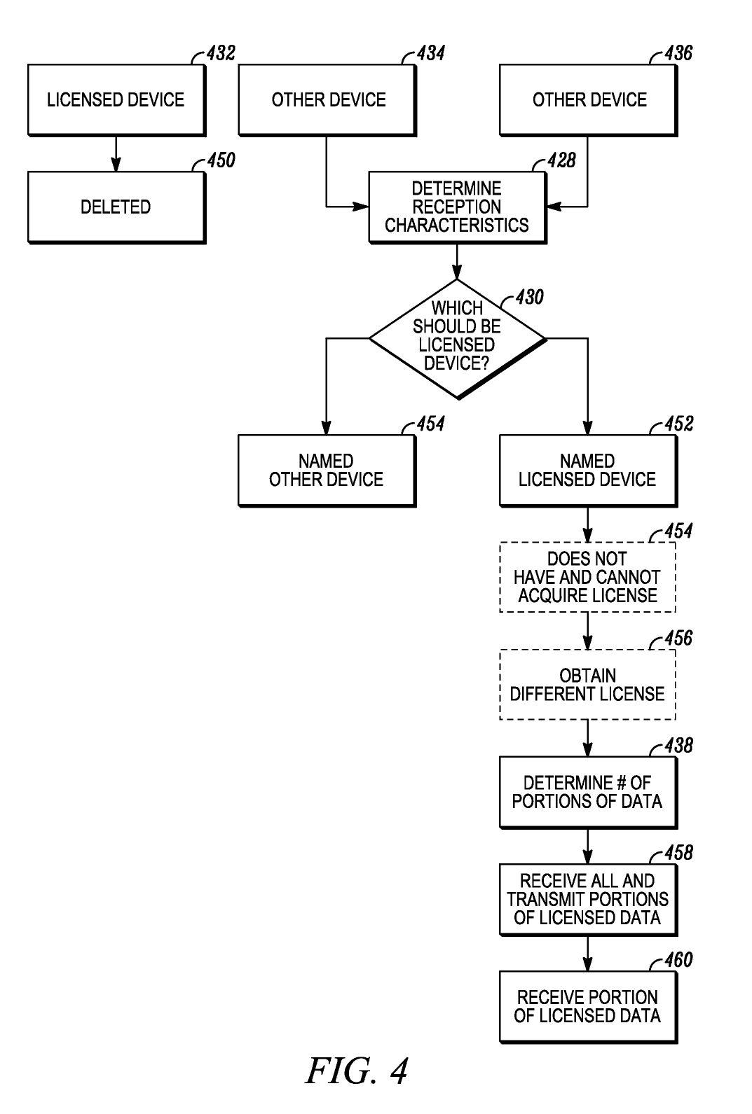

FIG. 4 is a flowchart of an embodiment of a method of deleting the licensed device and determining which device of clustered displays 100 (see FIG. 1) should take over as a licensed owning unit, or licensed device. After deleting 450 the licensed device 432 from the cluster, a reduced cluster 100 (see FIG. 1) of devices 434 and 436 is formed. The method may include determining 428 one or more reception characteristics of two or more devices of the reduced cluster 100. Selecting 430 from the two of more devices 434 and 436 a device based on the one or more reception characteristics as a new licensed device 452. The reduced cluster 100 includes the new licensed device 452 and one or more other devices 454. The new licensed device 452 is configured to be an owning unit of a license to receive data including licensed content. In the event that the new licensed device 452 does not have and cannot acquire a license 454 to receive the data including licensed content, the method can include obtaining 456 a different licensed to either the same content or different content. The data may be divided by the new licensed device 452 into one or more portions of the data and transmitted 458 to one or more other devices 454 so it may be received 460 by one or more other devices 454.

The reduced cluster, formed by removing the licensed device 432, may be unable to continue receiving the content, It is possible that the remaining units are unable to receive the content at suitable quality or may be unable to otherwise acquire a license to receive the content. If the reduced cluster is no longer able to display the content, then at least one unit of the cluster would display options for other content that could be displayed by the reduced cluster. The units in the reduced cluster may communicate with each other as in 324 and exchange a list of content that can be displayed by each unit, allowing at least one unit to determine and display content that could be displayed by the reduced cluster.

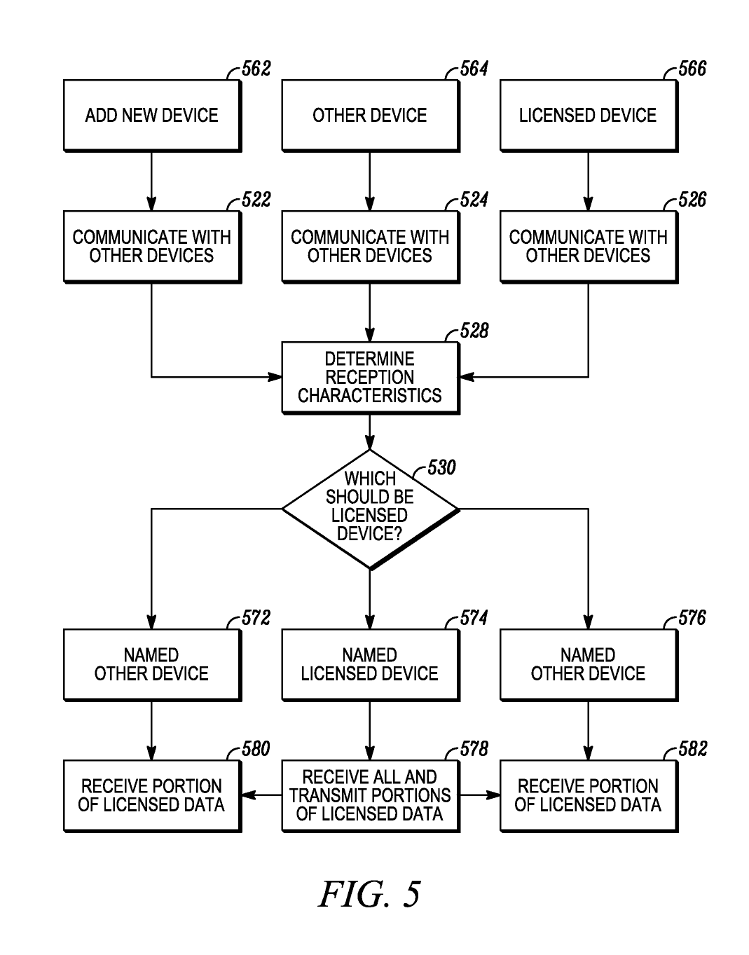

FIG. 5 is a flowchart of an embodiment of a method of determining which device of clustered displays 100 (see FIG. 1) should be a licensed owning unit, or licensed device after adding a device to the cluster so as to form an increased cluster 100. The method includes determining 528 one or more reception characteristics of two or more devices of the increased cluster 100 and selecting 530 a device from the two of more devices based on the one or more reception characteristics as a new licensed device 574. The cluster 100 includes the new licensed device 574 and one or more other devices 580 and 582, the licensed device 574 configured to be an owning unit of a license to receive data including licensed content. The licensed device 574 can receive all of the licensed data and transmit 578 one or more portions of the data to one or more other devices 580 ad 582.

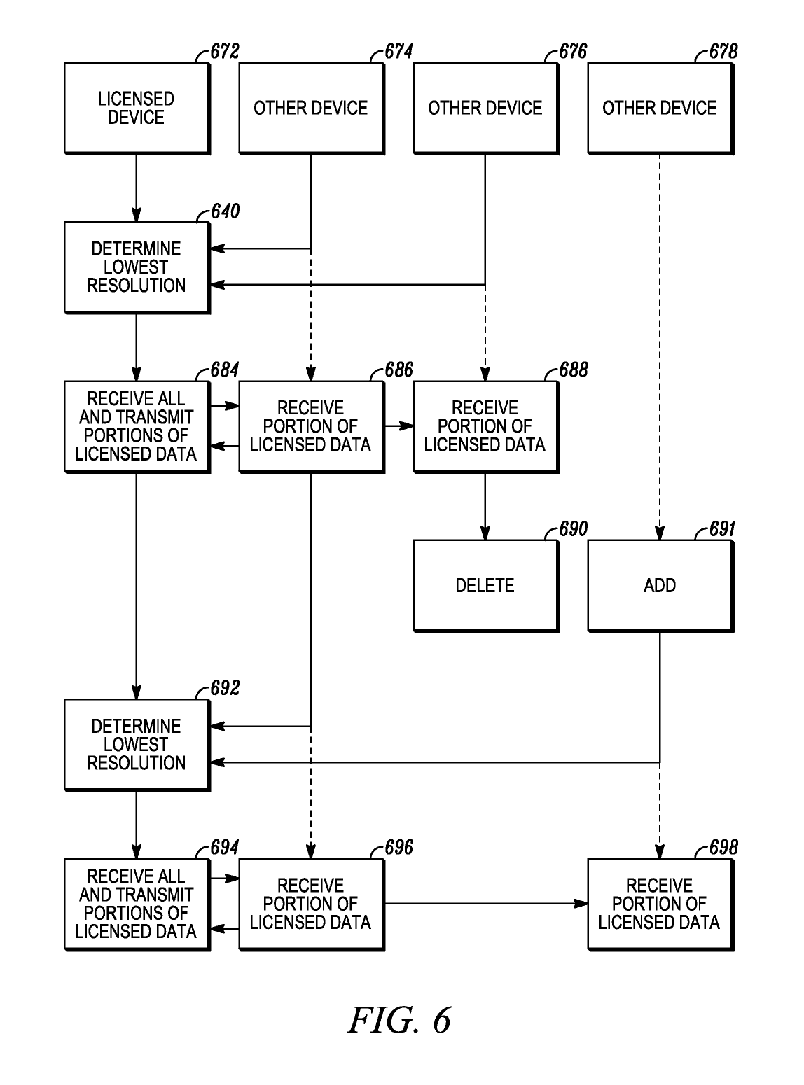

FIG. 6 is a flowchart of an embodiment of a method of a license owning unit 672 determining the resolutions of the cluster 100 (see FIG. 1) when devices are deleted and/or added to the cluster. As discussed above, upon determining the lowest resolution of the devices of the cluster 100 (see FIG. 1), the output of the data can be scaled at a resolution equivalent to the lowest resolution. The output can then be displayed by the cluster 100 at the lowest resolution. Adjusting the output resolution can provide a consistent content output across the cluster 100. For example, one display may be able to display in high definition with a high number of pixels/square area, a second display may have a much lower resolution. The more capable unit would aggregate pixels near each other to mimic a lower capability display. An aggregate display resolution module 240 is configured to determine the resolutions of each display device of cluster, determine which of the resolutions is the lowest resolution, and scale the output data to have a resolution equivalent to the lowest resolution.

The license owning unit 672 can receive all the content data and transmit 684 portions of the licensed data so that other devices 674 and 676 can receive portions of the licensed data 686 and 688. In one circumstance, one of the devices of the cluster 100 (see FIG. 1) may be deleted 690. In another situation, another device 678 may be added 691. The new device may have a different or lower resolution than the previously clustered devices and so the determination 692 of the lowest resolution by the licensed device 672 may occur again. The license owning unit 672 can receive all the content data and transmit 694 portions of the licensed data so that other devices 674 and 676 can receive portions of the licensed data.

When there is a plurality of devices forming clustered displays, the digital rights management of the content may be determined by the devices themselves. Accordingly, there may be a master/slave arrangement of devices, at least in terms of content delivery. It is understood that in the event that a particular cluster has been formed previously, data relating to the reception quality, and the resolution characteristics of the devices of the cluster may be stored in the memory 214 of one or more devices so that the process of determining those values does not necessarily need to be repeated. The disclosed devices and methods may streamline the process of obtaining a license by one device of the clustered displays and avoid duplicity of licenses taken by two or more devices of the clustered displays, while providing a consistent image across the cluster by displaying the content in accordance with the lowest resolution of any of the devices of the cluster.

This disclosure is intended to explain how to fashion and use various embodiments in accordance with the technology rather than to limit the true, intended, and fair scope and spirit thereof The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a cluster including a plurality of devices, each including a display device and at least one transceiver, the plurality of devices configured in an interrelated arrangement, comprising:
determining one or more reception characteristics of two or more devices of the cluster;
selecting a device from the two of more devices based on the one or more reception characteristics as a licensed device so that the cluster includes the licensed device and one or more other devices, the licensed device configured to be an owning unit of a license to receive data including licensed content; and
transmitting by the licensed device one or more portions of the data to one or more other devices.

2. The method of claim 1, wherein determining one or more reception characteristics comprises:
determining which device has the best reception quality.

3. The method of claim 1, wherein a number of portions of the data is determined by a number of devices in the cluster.

4. The method of claim 1, further comprising:
determining the resolution of each display device;
determining which resolution is the lowest resolution;
scaling output of the data to have a resolution equivalent to the lowest resolution; and
displaying the content at the lowest resolution.

5. The method of claim 1, further comprising:
deleting the licensed device from the cluster to form a reduced cluster;
determining one or more reception characteristics of two or more devices of the reduced cluster;
selecting a device from the two of more devices based on the one or more reception characteristics as a new licensed device so that the reduced cluster includes the new licensed device and one or more other devices, the new licensed device configured to be an owning unit of a license to receive data including licensed content; and
transmitting by the new licensed device one or more portions of the data to one or more other devices.

6. The method of claim 5, wherein if a new licensed device does not have and cannot acquire a license to receive the data including licensed content, the method further comprises:
generating a query to determine different licensed content.

7. The method of claim 6, wherein if the new licensed device fails to become an owning unit of a license to receive the data including licensed content, the method further comprises:
determining whether the new licensed device is configured to be an owning unit of a different license to receive different data including different licensed content;
transmitting by the new licensed device portions of the data to each of the plurality of other devices if the new licensed device is configured to be an owning unit of the different license to receive the different data including different licensed content.

8. The method of claim 1, further comprising:
adding a new device to the cluster to form an increased cluster;
determining one or more reception characteristics of two or more devices of the increased cluster;
selecting a device from the two of more devices based on the one or more reception characteristics as a new licensed device so that the cluster includes the new licensed device and one or more other devices, the licensed device configured to be an owning unit of a license to receive data including licensed content; and
transmitting by the new licensed device one or more portions of the data to one or more other devices.

9. The method of claim 8, wherein the new licensed device is an originally licensed device.

10. The method of claim 8, further comprising:
determining the resolutions of each of display device of the increased cluster;
determining which of the resolutions is the lowest resolution;
scaling output of the data to have a resolution equivalent to the lowest resolution; and
displaying the licensed content at the lowest resolution.

11. The method of claim 1, further comprising:
determining a list of content that can be received by each device of the cluster; and
annunciating the list of content by an output device.

12. A method of a cluster consisting of a plurality of display devices, each configured with a resolution for output of data, the cluster configured in an interrelated arrangement, comprising:
determining the resolutions of each display device;
determining which of the resolutions is the lowest resolution;
scaling output of data at a resolution equivalent to the lowest resolution; and
displaying output of the cluster at the lowest resolution.

13. The method of claim 12, further comprising:
deleting a device of the cluster to form a reduced cluster;
determining which of the resolutions is the lowest resolution of the reduced cluster;
scaling output of data at a resolution equivalent to the lowest resolution; and
displaying output by the reduced cluster at the lowest resolution.

14. The method of claim 12, further comprising:
adding a device to the cluster to form an increased cluster;
determining which of the resolutions is the lowest resolution of the increased cluster;
scaling output of data at a resolution equivalent to the lowest resolution; and
displaying output by the increased cluster at the lowest resolution.

15. A communication device configured to be a part of a cluster of devices, comprising:
a controller;
a memory configured to communicate with the controller and configured to store modules;
at least one transceiver configured to communicate with the controller;
a display device configured to communicate with the controller;
a cluster module in communication with the controller, the cluster module configured to determine that the device is a license owning unit;
a content module in communication with the controller, the content module configured to receive data including content via a transceiver when it is determined that the device is a license owning unit; and
a distribution module in communication with the controller, the distribution module configured to transmit output data via a transceiver, the output data being at least one portion of the data.

16. The device of claim 15, wherein a number of the portions of the data determined by a number of devices in the cluster.

17. The device of claim 15, further comprising:
an aggregate display resolution module in communicate with the controller, the aggregate display resolution module to configured to:
determine the resolutions of each display device of cluster;
determine which of the resolutions is the lowest resolution; and
scale the output data to have a resolution equivalent to the lowest resolution.

18. The device of claim 15, wherein the display device is a borderless display.

19. The device of claim 15, wherein the communication device is a mobile communication device.
